(19) United States
(12) Patent Application Publication
(10) Pub. No.: US 2018/0127126 A1
(43) Pub. Date: May 10, 2018

(54) METHOD FOR CONTROLLING THE PRESSURE IN A CONTAINER WITH THE CONTENTS THEREOF AFTER FILLING AND PLUGGING, AND RELATED DEVICE

(71) Applicant: JALCA, Le Havre (FR)

(72) Inventor: Jean-Guy DELAGE, Le Havre (FR)

(21) Appl. No.: 15/565,464

(22) PCT Filed: May 6, 2016
(86) PCT No.: PCT/FR2016/051072

§ 371 Date: Oct. 10, 2017

(30) Foreign Application Priority Data
May 5, 2015 (FR) 1554005

(51) Int. Cl. B65B 31/00; B67C 3/22

(52) U.S. Cl. CPC B65B 31/006; B67C 2003/226; B67C 3/22

(57) ABSTRACT

Disclosed is a method for controlling the pressure in a container with the contents thereof after filling and plugging and particularly to a method for treating a drinking liquid or semi-liquid in a polymer material bottle. The method includes the following steps: filling the container, closing the container using a plugging unit, adding a fluid into the head space through a hole bored through the plugging unit so as to obtain a residual pressure greater than atmospheric pressure, and sealing the hole in the plugging unit by melting the material of the plugging unit. Also disclosed is the related device.

The present invention relates to a method for controlling the pressure in a container with the content thereof after filling and stoppering, namely to a method for treating an acidic drinking liquid or semi-liquid such as a fruit juice in a bottle made of a polymeric material.

The present invention also relates to an associated device allowing to implement the method.

The term “content” refers hereinafter to a drinking liquid or semi-liquid product to be sold outside the cold chain, in a container, a container according to the present invention being a shell made of a polymeric material such as a bottle, provided with a known type of stopper, intended to sealingly close the bottle after filling, generally with a screw.

The packagings made of a complex comprising cardboard, aluminum sheet and polymer sheet, and the packagings made of glass, metal and laminated plastic film forming pockets, do not form part of the present invention.

The drinking liquid or semi-liquid contents are sensitive to the microbial growth and the organoleptic qualities are modified very quickly without a treatment for sterilizing the pathogens and/or in the presence of oxygen.

In a known manner, the heat treatment at a high temperature of about 90° C. for a few seconds, also called flash pasteurization, is also applied to drinking liquids or semi-liquids with a pH lower than 4.7 such as, for example, juices. According to this method, the liquid is treated in a specific unit, before filling which should be performed in a sterile manner. Thus, it must be ensured that the chain remains sterile.

This filling method consists in a sterile cold filling process. The container and its stopper are cold sterilized by means of a sterilization liquid and a rinsing, and the content is then introduced in this container in an aseptic atmosphere. The advantage is to use packagings which require limited amount of material since the necessary mechanical properties are limited. The method does not generate variations in volume related to the variations in temperature. In addition, the necessary mechanical properties being limited, the outer aesthetic shapes are more diversified. However, the oxygen contained into the head space can be consumed and a depression occurs in the bottle. Thus, it is necessary to provide either a bottle which sustains this depression or to compensate for this depression.

This “sterile” technique induces complex and expensive facilities, with a thorough and expensive maintenance. In addition, the quality control can be performed only by sampling, thus there is no systematic control and no certainty as to the sterilization of the drinking liquid or semi-liquid content conditioned thereby.

Another known solution is that of sterilization simultaneously to filling by introducing a sterilizing liquid. It is understood that the addition of a sterilizing product, which is a chemical compound, is not necessarily accepted by all health regulations of the countries and that the user himself/herself can be reluctant to absorb, not only the drinking liquid or semi-liquid product he/she has chosen, but also the residual sterilizing product introduced. Moreover, the addition of a sterilizing product should be mentioned on the labels and such products will not form part of the “organic” or “without preservatives” categories, even if such products do have these qualities of products without preservatives or organic products during their production.

Such preservation agents can induce modifications of the organoleptic qualities during the storage as well as after opening the packaging.

A last solution among the main known solutions of the prior art consists in the hot filling of a packaging, namely introducing the content at high temperature directly into the container without the latter undergoing a sterilization treatment. In this case, the content itself ensures the sterilization of the container since it is introduced at a temperature allowing to kill pathogens, thus a temperature higher than 73° C., generally 75° C.

The packaging is closed and then immediately shaken, generally by flipping, so as to thermally treat all internal surfaces of the container, including the internal face of the stopper.

The stopper, in the case of hot stoppering, is a monomaterial known type stopper, obtained by molding, controlled before being fitted so as to avoid placing a defective stopper. Such stoppers are extremely cheap.

The solution is interesting since it ensures that each packaging is necessarily sterilized internally, without any oversight possible.

If the stopper is cheap, the disadvantage of hot filling is that it requires a packaging which, on the one hand, sustains the temperature and, on the other hand, the phenomenon of collapse related to the retraction of the liquid volume when cooling, thereby creating a depression inside said container. Moreover, the oxygen of air trapped when filling is also “consumed” after cooling by the drinking liquid or semi-liquid composition, thereby causing a delayed depression which can also cause an additional deformation of the container.

Thus, the packaging should be mechanically resistant and/or deformable, requires a high amount of material and generally a specific architecture with panels to withstand the deformations of this packaging and/or compensate for the depression by appropriate deformations. Thus, bottoms can adopt two positions, one of these being a deformation inward under the effect of the depression so as to compensate for said depression. The deformation of the bottom being below the bottle, it does not create a problem of stability of the bottle when it rests on said bottom, only the recess of the bottom is accentuated, which is not visible, except when looking from below. It can be understood that such a bottom has to be sophisticated, complex to produce, and induces an obvious extra cost.

It can be noted that this goes against the sustainable development needs intended to reduce the amounts of polymer material used, which also has an impact on the production cost and recycling, thus an impact on the final price.

However, this method is the one requiring the simplest conditioning lines either for installation or maintenance, which is simple to control since the main control only has one parameter: the temperature of the content.

Other compensating solutions have been implemented, for example, one solution consists in introducing a liquid nitrogen drop into the head space immediately before stoppering. The liquid nitrogen transitions to the gaseous state with a very high increase in volume, thereby pressurizing the volume of the bottle and allowing to compensate, as cooling continues, for the volume of liquid retraction. In the final state, at ambient temperature, an equilibrium is created and the nitrogen can only cause an additional inerting. This method is relatively complex to control and difficult to reproduce.

Improvements in methods and materials of containers allowed to improve the performances. The market of several billions of bottles is very incentivizing.

However, the aim, which is also the object of the present invention, is to be able to perform hot filling by means of bottles having the lowest possible material overweight with respect to the containers used for cold filling in a sterile atmosphere.

It is also useful to be able to compensate for the depression in cold-filled containers which can also undergo deformations by depression, or else to improve their mechanical strength, especially if the containers themselves have a low mechanical strength, which is also an object of the present invention.

It is thus necessary to provide a method for compensating for the depression in a container, this being a minimum, and more generally for controlling the overpressure, especially in the case of hot filling. This overpressure, after cooling, allows to compensate for the volume decrease of the head space which is of a few percents while cooling. This overpressure also allows in the end to compensate for the pressure decrease related to the oxygen consumption.

These different sources of pressure decrease, when no compensation or even overpressurization is provided, cause a deformation of the bottle and renders it unsuitable for marketing.

These depressurizations also cause a bad grip by consumers, but also a poor mechanical strength of the containers during transportation on pallets, even when film-wrapped.

Patents providing a compensation method are known, such as patent application FR 2 322 062 A1 which suggests to inject a gaseous fluid into the head space through a specific stopper member. Such a device consists in introducing a needle through the stopper member, injecting a gas through the needle into the head space, and removing said needle, the stopper member ensuring itself the sealing. It appears that a stopper member with specific means is required, which is entirely unacceptable in view of the packaging price. In addition to the price and, as a complement, this generates complex problems relating to the presence of several materials, to the complexity of quality control, to the difficulties of recycling and to the lack of certainty concerning the quality of stoppering. In this case, a membrane which can only act as a barrier to the liquid for hot filling is provided, for example, since the liquid will not pass behind the membrane and then the stopper member is perforated, thereby introducing potential organisms located behind the membrane which will migrate into the container.

Another device also uses an even more specific stopper, which is described in patent application WO 2009142510 A1. This stopper is made with an opening. After filling, the head space is arranged in a pressurized enclosure, a stoppering piece is introduced in the hole provided for this purpose, said stopper being immobilized in the hole by mechanical means.

Such a method cannot be industrially contemplated, whether in terms of rates, or price and difficulties for control, and even for the implementation.

The present invention relates to a method for controlling the pressure generated in the head space of a container with the content thereof, filled and closed, in particular during the hot filling of a bottle, in particular with at least one compensation of the depression when cooling, or even related to the oxygen consumption.

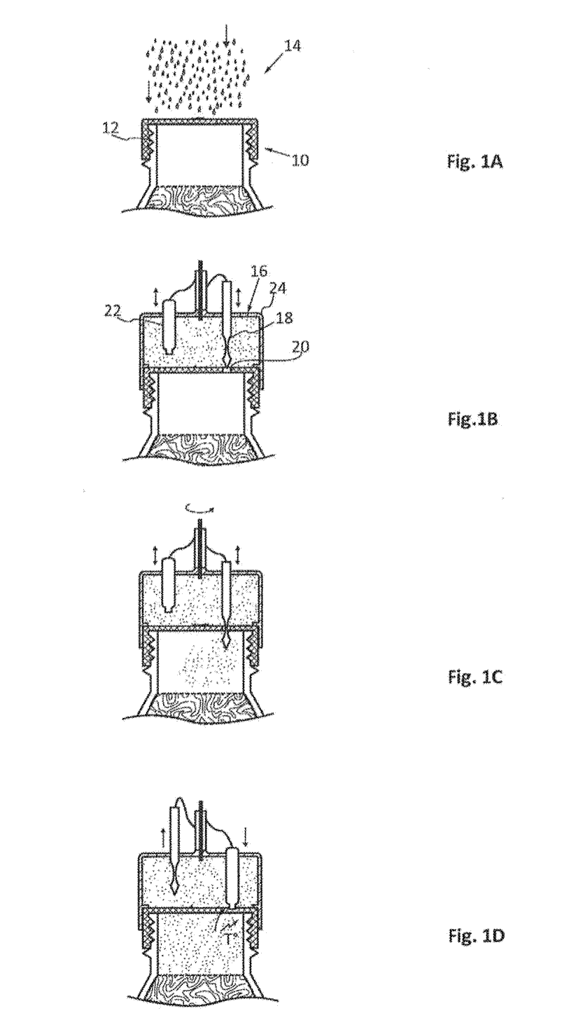

The method will now be described in relation to the synoptic shown in appended FIGS. 1A-1D.

The device is also schematically described, as well as the results obtained.

This description is established according to a non-limiting particular embodiment, for a container which is a bottle.

The description of the device and its different embodiments is also provided.

The method and device are illustrated in the appended drawings in which the different figures show:

FIG. 1A: a view of the initial step for sterilizing the stoppering means,

FIG. 1B: a view of the combined means for punching/sealing by melting, during the punching step,

FIG. 1C: a view of the combined means for punching/sealing by melting, during the injecting step,

FIG. 1D: a view of the combined means for punching/sealing by melting, during the sealing by melting step,

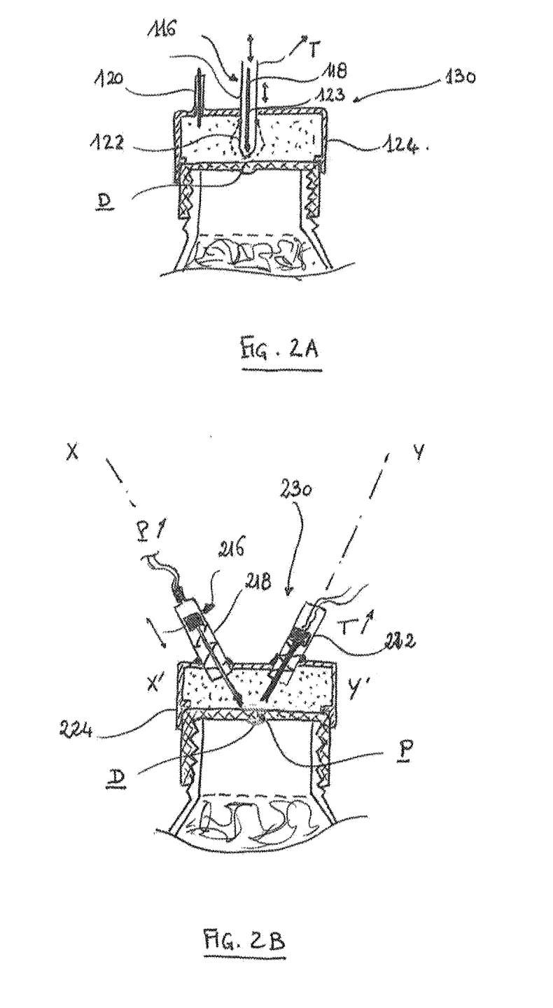

FIG. 2A: a different embodiment of a device allowing to limit the movements compared to the arrangement shown in FIG. 1,

FIG. 2B: another different embodiment of a device also allowing to limit the movements,

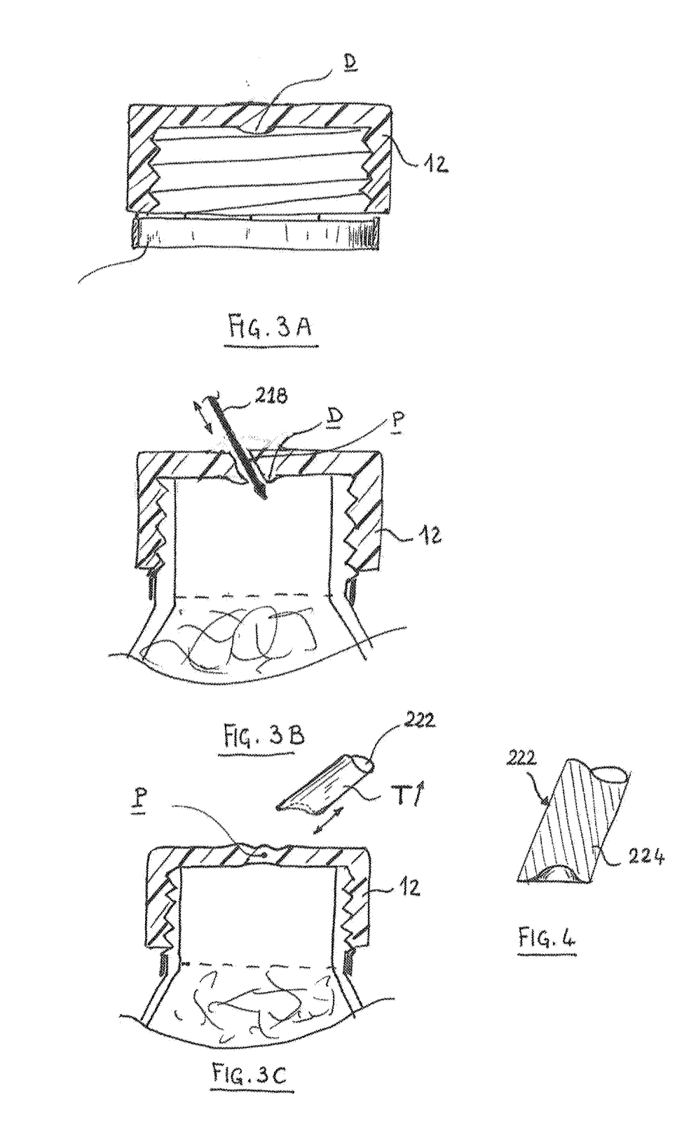

FIG. 3A: a cross-sectional view of a known type stopper, before punching,

FIG. 3B: a cross-sectional view of the stopper of FIG. 3A, after punching,

FIG. 3C: a cross-sectional view of the stopper after sealing by melting,

FIG. 4: a cross-sectional view of a melting cannula according to the present invention, used in FIG. 3C.

In the case of the present description, the method for controlling the pressure in the head space of a container filled with the content thereof is performed in relation to a complex example combining all the problems. This method is a method for hot filling of a container, in particular made of PET, poly(ethylene terephthalate), with a low basic weight, with a content such as a fruit juice, heated at a temperature adapted to kill the pathogens, namely a temperature higher than 73° C., in particular 75° C.

Once the container is filled with the hot content, it is stoppered by known type stoppering means, such as a screw stopper which is injection molded, monolithic and free from any additional sealing component.

This is the definition which is retained for the following description. The stoppering means are constituted by a monolithic stopper made of a single material.

The sealing is obtained by contact through mechanical pressure of the stopper material, namely its inner face, on the material of the peripheral edge of the neck, the screwing allowing to apply said required mechanical pressure.

When closing, said stopper leaves a head space. This space first results from filling without overflow since the content should not in any case overflow and be on the lip of the neck before closing since the content would be an open door under the stopper and the container would be unsuitable for selling.

The stoppering means are free from any mechanism or any other accessory for compensating for the pressure. The air trapped into the head space is hot, but is at atmospheric pressure.

The container is adapted to receive a content at the retained sterilization temperature without any degradation, but is free from means for compensating for the pressure.

The method provides for moving the container, immediately after filling with the content, so as to put all the internal surfaces of the container in contact with the content heated at the sterilizing temperature.

The container and its liquid are then cooled down into a cooling channel by spraying water, for example, for bringing the assembly close to ambient temperature.

When the container reaches a temperature lower than 75° C., due to its constituting material, said container collapses since the volume of gas and liquid reduces up to 3-5% inside the container. This reduction increases as cooling continues. The phenomenon of collapse is close to its maximum at a temperature lower than or equal to 45° C.

The method according to the present invention provides for an injection of gas into the head space of the container, in particular an inert gas, by a passage through the stoppering means, at any time during cooling, but more particularly when the temperature is lower than or equal to 45° C.

The following step consists in sealing by melting the passage generated by the injection operation through the stoppering means, said sealing being performed within a duration of between 0 and 5 seconds.

The injection pressure and the stoppering duration are combined such that the residual pressure in the container is higher than the atmospheric pressure, more particularly between 1.01 bar and 2.5 bar, and more particularly between 1.01 bar and 1.4 bar.

According to an improvement of the invention, the stoppering means are externally sterilized before punching, by a one-off heating or chemical sterilization.

Preferably, the injection is performed using a needle, in a sterile atmosphere. The needle can also be itself heated, not at the melting temperature of the stopper it punches through, but just at a sterilization temperature, for example 90° C.

The gas injected is preferably an inert gas so as to prevent the subsequent oxidation of the content, after bottling, for example nitrogen, namely in liquid form. This prevents over-collapsing due to the subsequent oxygen consumption since there is very little or even no oxygen, the inert gas replacing in a large part the air initially confined. Stoppering of the passage is ensured by melting the material of the stoppering means thus punched concurrently with the removal of the needle with a hot cannula, provided with heating means, more particularly by melting the material on the edges of said passage after removing the needle and generated by the needle when pushing the material.

The container thus contains contents with a balanced pressure, preferably under a slight pressure, such that the inner pressure difference with the outer pressure of the bottle avoids generating any collapse.

Preferably, a slight overpressure is provided since when cooling at a cold temperature, as that of a fridge, a new gas contraction is caused into the head space which is also prone to cause some kind of collapse.

When filling and pressurizing, the pressure can vary during filling.

For example, it is possible to highly increase the pressure in the initial phase of pressurizing, immediately after punching, and have a final phase with a less important pressure so as to adjust the final pressure, just before closing by welding.

In the appended figures, the steps of the method are schematically shown with a device allowing to implement the method described above.

In FIG. 1A, it is suggested to sterilize the stoppering means 10 of the container with the content thereof after filling, for example, by a projection of sterilizing liquid 14. These stoppering means comprise a stopper 12. The sterilizing liquid ensures the destruction of the pathogens present on the outer surface of the stopper.

In FIG. 1B, after sterilizing, combined means 16 are used, comprising punching means 18, injecting means 20 and means 22 for sealing by melting the material constituting said stopper, these elements being arranged in a cover 24 having the stopper shape. Advantageously, the punching means 18 and the sealing means 22 are diametrically arranged with respect to the cover. During this step, the cover 24 is sealingly abutted on the stopper. This step for abutting the cover 24 is achieved by sweeping an inert gas such as nitrogen gas, under pressure below this cover. The punching means 18 punch a hole by penetrating the plastic material, by deforming and pushing the material, without any removal of material. The diamond tip can be an advantageous shaped to avoid any removal of material, thus the material is only pushed at the periphery of the hole.

In FIG. 1C, it can be noted that the punching means 18 comprise a throttle allowing to punch a hole with a diameter greater than that of the throttle. Thus, by pressurizing the inner volume contained in the cover, it is possible to inject a gas by the diameter difference between the throttle and the punched hole. The pressure of the head space and the pressure of the containment volume of the cover becoming balanced.

The head volume of the container is thus pressurized, with the pressure identical to that generated below the cover 24.

In FIG. 1D, the cover 24 is rotated to position the sealing means 22 directly above the punched hole. The sealing means 22 are constituted by a hot cannula 23 which melts the plastic material of the stopper so as to seal the hole by melting the material of said stopper. A hot cannula 23 with one substantially spherical end is adapted and used in the schematic embodiment shown.

It is understood that the container thus pressurized or under slight pressure does not lead to a problem of stability since the pressure is lower than the pressure which would cause a deformation of the bottom, for example. This overpressure reinforces the rigidity of said container even if said container does not have the sufficient initial mechanical strength.

Such method allows hot filling in containers, for example made of PET, poly(ethylene terephthalate), with reduced basic weights of about 10 g of material for a volume of 1 liter, this being a significant material reduction considering the multiplying factor of the number of containers produced.

No particular architecture should be provided for the wall, any complex petal bottom and/or technical panel becomes unnecessary.

Thus, the shapes of the containers are much more free and plain, recycling is less expensive since the quantity of material used is reduced.

Arranging the container under atmospheric pressure or slight pressure allows stacking and palletizing.

Such method for controlling the pressure in a container with the content thereof and sealed, according to the present invention, can be applied to all filling modes and even for pressurizing the cold-filled containers in a sterile atmosphere, to compensate for a potential decrease in volume of the head space by an oxygen consumption and also apply a slight overpressure to reinforce the mechanical strength, or even inject an inert gas for replacing the air contained in the head space to preserve all organoleptic qualities of the products which can be affected by oxidation.

The problem of the presence of oxygen is also due to the penetration of oxygen through the wall of the container. Indeed, in any case, the oxygen migrates ambient air toward the interior of the container in a quantity of about 0.06 ppm/day through the wall of said container.

The air contains about 20% of oxygen for 1 liter, so that the head space of 25 ml contains 5 ml of oxygen. If this oxygen is replaced by an inert gas, the preservation duration of the organoleptic qualities is increased by 100 days for the preservation of the qualities.

In FIG. 2A, a device is shown according to a different embodiment, the identical references having the same reference numerals increased by 100.

This device 130 has the same elements as above, namely combined means 116 comprising punching means 118, injecting means 120 and sealing by melting means 122, these elements being arranged in a cover 124 having the shape of a stopper.

In this embodiment, an architecture is provided with the punching means 118 and the sealing by melting means 122, which are combined.

In this case, the punching means 118 are in a central position, the sealing by melting means 122, forming a hot cannula 123, have an adjustable diameter by intrinsic deformation or a petaloïd link, such that the punching means 118 can pass through, the mechanics being within the knowledge of the one skilled in the art.

This arrangement avoids the rotation of the cover 24 which is thus suppressed, as well as the time of this phase.

Indeed, the rate on a carousel is about a few seconds, lower than 5 seconds, so as to avoid the use of carousels with a too significant number of stations.

Moreover, the superimposed central position allows to operate in an area of the stopper which has a recess, integrally formed by injection, which leaves an injection trace, namely a dome D on the lower face. This is visible in FIG. 3A.

According to another embodiment, in FIG. 2B, the identical references have the same reference numerals but increased by 200.

This device 230 comprises the same elements as above, namely combined means 216 comprising punching means 218, injecting means 220 and sealing by melting means 222, these elements being arranged in a cover 224 having the shape of a stopper.

In this embodiment, an architecture is provided with the punching means 218 and the sealing by melting means 222, inclined with respect to each other with the displacement longitudinal axes XX′ and YY′, intersecting at a same point P, at the surface of the stopper.

Preferably, the point P is arranged directly above the dome D, more particularly within the thickness of the stopper at this location.

Punching by pushing further pushes the material and, as shown in FIG. 3B, a material bead is formed, in particular using a diamond-profile tip.

In this same figure, the sealing by melting means 222 comprise a cannula 223 also with a particular end profile, with a concave bowl shape. Instead of a convex hemispheric end, the bowl shape of the end can be preferred since it accumulates, by melting, the material in the bowl and allows a confined central heating. This is useful considering the melting time which is nearly instantaneous.

Such shape can be useful when air or an inert gas is injected through the punching means themselves, without any chamber. The head space is then pressurized and the air or inert gas is pressurized and will exit through the hole created. Melting being performed before the pressure is returned to the ambient pressure, there is still an inner overpressure.

However, the exiting air or inert gas causes the hot cannula 223 to be cooled.

Yet, the shape of the hot cannula in FIG. 3C, magnified in FIG. 4, on one hand, restricts the exhaust of pressure and, on the other hand, restricts cooling.

This cannula shape is adaptable to all arrangements described above.

The different embodiments of device show the possibilities of arrangement and the relevance of punching and sealing by melting, without supplying any material, within a few seconds, the tests leading to operating times of the complete cycle of 2-3 seconds, which is lower than the residence time on a carousel only provided with 12 stations, for example.

1-13. (canceled)

14. A method for controlling the pressure in a polymeric material container having a drinking liquid or semi-liquid content, wherein the method comprises the following steps:
filling the container with a drinking liquid or semi-liquid content,
stoppering said container using a monomaterial stopper,
punching a hole through the monomaterial stopper,
introducing a fluid into the head space through said hole punched through the monomaterial stopper, so as to obtain a residual pressure at least equal to atmospheric pressure in the head space, and
sealing said hole in the monomaterial stopper by melting the material of the monomaterial stopper.

15. The method for controlling the pressure in a container according to claim 14, wherein, in the case of hot filling, the fluid is introduced into the head space after cooling at a temperature lower than 45° C.

16. The method for controlling the pressure in a container according to claim 14, wherein the fluid introduction pressure is adapted to generate a residual pressure into the head space of the container, between 1.01 bar and 2.5 bar, more particularly between 1.01 bar and 1.4 bar.

17. The method for controlling the pressure in a container according to claim 14, wherein the fluid is an inert and sterile gas.

18. The method for controlling the pressure in a container according to claim 14, wherein the steps of introducing the fluid and sealing are performed in a sterile environment.

19. The method for controlling the pressure in a container according to claim 14, wherein the fluid introduction is performed using a needle, by one of a chemical sterilization and the heat from the outer surface of the monomaterial stopper before the introduction of said needle.

20. The method for controlling the pressure in a container according to claim 14, wherein the fluid is added through the punching means.

21. A device for implementing the method according to claim 14, wherein the device comprises combined means arranged on a cover comprising:
means for punching a hole,
means for injecting a fluid through said hole, and
means for sealing by melting the hole.
wherein the punching means and the sealing means are arranged such that their displacement axes XX′ and YY′ intersect at a point P arranged within the material of said stopper.

22. The device according to claim 21, wherein the melting by sealing means comprise a hot cannula.

23. The device according to claim 22, wherein the hot cannula has an end with a concave bowl shape.
